(19) United States
(12) Patent Application Publication
(10) Pub. No.: US 2011/0081946 A1
(43) Pub. Date: Apr. 7, 2011

(54) APPARATUS AND METHOD FOR CHANGING AN IMAGE-CAPTURING POSITION OF A MOBILE PHONE CAMERA USING A MIRROR DEVICE

(76) Inventor: Byron Singh N John Singh, Santa Clara, CA (US)

(21) Appl. No.: 12/575,460

(22) Filed: Oct. 7, 2009

(51) Int. Cl. H04M 1/00; G02B 5/08; H04N 5/225

(52) U.S. Cl. 455/556.1; 348/335; 359/857; 348/E05.024

(57) ABSTRACT

An apparatus and a method are disclosed for changing an image-capturing position of a mobile phone camera using a mirror device. In one embodiment of the invention, the mirror device has a first mirror surface which reflects an image into a second mirror surface that further reflects and redirects the image into a lens of a mobile phone camera. Furthermore, the mirror device also has a material positioned between the first mirror surface and the second mirror surface to enable tilting of mirror surfaces, wherein the material typically contains a non-reflective surface and one or more hinges. It is preferred that the mirror device also has Velcro surfaces which attach to a surface exposing the mobile phone camera. In addition, a software program can be used to invert the image reflected into the lens of the mobile phone camera.

### BACKGROUND OF THE INVENTION

The present invention generally relates to a mobile phone camera. More specifically, the present invention relates to an apparatus and a method for changing an image-capturing position of a mobile phone camera using a mirror device containing image-reflective surfaces.

Today's cellular phones (i.e. “mobile” phones) reflect a continuing trend in digital convergence. Once a mere voice-capable device used as a portable telephone, a typical mobile phone in the market today integrate many personal data assistant (PDA) features as well as multimedia functions such as image-capturing and music-playback capabilities. A mobile phone capable of image-capturing capability typically includes a camera lens on an exterior surface of the mobile phone. The image-capturing capability for a typical mobile phone has improved over the last several years, starting from a lower-quality (e.g. QVGA and VGA resolution) resolution for still and moving pictures in its initial debut on mobile phone applications to multi-mega-pixel high quality still and moving pictures (e.g. SVGA resolution or higher) in recent mobile phone models. An increasing transistor density in semiconductor devices and a continuing price decline in mobile phone camera components contributed to higher-quality image processing on newer mobile phone models.

As mobile phone users utilize image-capturing capabilities of their mobile phones, some mobile phone manufacturers realize a need for providing a flexible camera lens position for image-capturing applications. For example, a user who wants to use his/her mobile phone camera in a web-cam-style “self-portrait” mode is greatly inconvenienced if his mobile phone camera has a lens only on a back surface of his/her mobile phone. Some phone manufacturers have attempted to resolve this user inconvenience by putting a second camera lens on a front surface of a mobile phone. In most cases, the second camera lens is a lower-quality and cheaper lens than a first camera lens typically placed on a back side of a mobile phone, because the second camera lens is perceived to be used as a web-cam-style “self-portrait” application by a cell phone manufacturer. The cost of integrating a second camera lens in a mobile phone is significant for the cell phone manufacturer, compared to a single camera lens model, because an exterior shell for a mobile device has to be a custom-made unit for the two camera lens models. Furthermore, the cost of the second camera lens and its integration is also more than a single camera lens counterpart. More importantly, despite a higher cost of designing and manufacturing the two-camera-lens mobile phones, many users still may not like the fact that the second camera lens on a front surface of a mobile phone does not take high-quality still or moving pictures. Therefore, a cost-benefit ratio of a two camera lens mobile phone for a mobile phone manufacturer may be undesirable.

Furthermore, the two-camera-lens mobile phones still only provide a limited angle (e.g. typically, a backside and a front-side of a mobile phone only) for image capturing. Nokia's U.S. patent application Ser. No. 11/440,701, filed on May 24, 2006 provides an alternative to using two camera lenses on a mobile phone by making a single camera phone lens to swivel around a pivot point, thereby allowing only a single camera lens to achieve an image-capturing capability around the pivot point. However, this type of swiveling-camera phone may face a difficult widespread industry acceptance because the swiveling-camera design is limited to a particular exterior design which integrates a camera-pivoting mechanism, and the cost of manufacturing such devices is likely to be high. Furthermore, an everyday reliability of a swiveling-camera phone is questionable because one or repeated drops of a mobile phone incorporating a swiveling camera lens may cause a dislocation or a breakage of the swiveling camera lens. Equally important, the two-camera lens design and the swiveling-camera lens design mentioned above typically require manufacturing-level integration of such features, with little to no aftermarket attachment potential. As a result, a cellular phone manufacturer and/or a phone accessory manufacturer incorporating existing multiple-position image-capturing solutions in a mobile camera phone faces a difficult prospect of charging a premium due to a lack of an aftermarket potential.

Therefore, an apparatus and a method for changing an image-capturing position of a mobile phone camera cost effectively may provide significant benefit to future mobile phone designs. Furthermore, such a cost-effective apparatus and/or method which are not phone model-specific and can be attached and detached easily from a variety of cellular phone casings may provide a high aftermarket profit potential for manufacturers.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, an apparatus for changing an image-capturing position of a mobile phone camera using a mirror device is disclosed. This apparatus comprises a first mirror surface configured to reflect an image into a second mirror surface, wherein the second mirror surface further reflects the image into a lens of the mobile phone camera; a material positioned between the first mirror surface and the second mirror surface, wherein the material has one or more hinges to connect the first mirror surface to the material and the second mirror surface to the material; a first Velcro surface attached to the apparatus; a second Velcro surface attached to a surface exposing the lens of the mobile phone camera, wherein the first Velcro surface and the second Velcro surface are configured to create a removable fixed position for the apparatus upon contact and wherein the surface exposing the lens of the mobile phone camera is either part of the mobile phone camera itself or part of a mobile phone camera cover; and a stabilizing arm attached to the apparatus, wherein the stabilizing arm is configured to stabilize the removable fixed position with an additional removable attachment contact point with a surface of the mobile phone camera.

In another embodiment of the invention, a method for changing an image-capturing position of a mobile phone camera using a mirror device is disclosed. This method comprises the steps of: using a first mirror surface to reflect an image from a position not normally facing a lens of the mobile phone camera; using a second mirror surface to redirect the image reflected from the first mirror, wherein a redirected image operatively reaches the lens of the mobile phone camera; and using a pair of Velcro strips to create a removably fixed and/or stabilized position between the second mirror surface and the mobile phone camera.

Yet in another embodiment of the invention, a method for changing an image-capturing position of a mobile phone camera using a mirror device is disclosed. This method comprises the steps of: using a first mirror surface to reflect an image from a position not normally facing a lens of the mobile phone camera; using a second mirror surface to redirect the image reflected from the first mirror, wherein a redirected image operatively reaches the lens of the mobile phone camera; and using one or more attachable surfaces to create a removably fixed and/or stabilized position between the second mirror surface and the mobile phone camera.

### BRIEF DESCRIPTION OF DRAWINGS

FIG. 1 shows a rear view of an apparatus for changing an image-capturing position of a mobile phone camera using reflective mirror surfaces, in accordance with an embodiment of the invention.

FIG. 2 shows a side view of an apparatus for changing an image-capturing position of a mobile phone camera using reflective mirror surfaces, in accordance with an embodiment of the invention.

FIG. 3 shows a frontal view of an apparatus for changing an image-capturing position of a mobile phone camera using reflective mirror surfaces, in accordance with an embodiment of the invention.

FIG. 4 shows a frontal view of a mobile phone and a partial frontal view of an apparatus for changing an image-capturing position of a mobile phone camera using reflective mirror surfaces, in accordance with an embodiment of the invention.

FIG. 5 shows a rear view of a mobile phone and a rear view of a folded apparatus for changing an image-capturing position of a mobile phone camera using reflective mirror surfaces, in accordance with an embodiment of the invention.

FIG. 6 shows a method for operating an apparatus for changing an image-capturing position of a mobile phone camera using reflective mirror surfaces, in accordance with an embodiment of the invention.

FIG. 7 shows another method for operating an apparatus for changing an image capturing position of a mobile phone camera using reflective mirror surfaces, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more apparatuses and methods for changing an image-capturing position of a mobile phone camera using a mirror device. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order and do not imply any limitations in the invention.

One objective of the present invention is to provide a cost-effective apparatus capable of changing an image-capturing position of a mobile phone camera using mirrors. Another objective of the present invention is to make such a cost-effective apparatus easily attachable and detachable from a surface of a mobile phone. A further objective of the present invention is to make an apparatus capable of changing an image-capturing position of a mobile phone camera using mirrors compact and unobtrusive when the apparatus is not in use.

For the purpose of describing the invention, a term “mirror device” is defined as a device with one or more image-reflective mirror surfaces capable of reflecting and redirecting images.

Furthermore, for the purpose of describing the invention, a term “mirror surface” is defined as a reflective side of a mirror capable of reflecting an image.

In addition, for the purpose of describing the invention, a term “removable” is used to refer to a changeable and/or detachable position of an element.

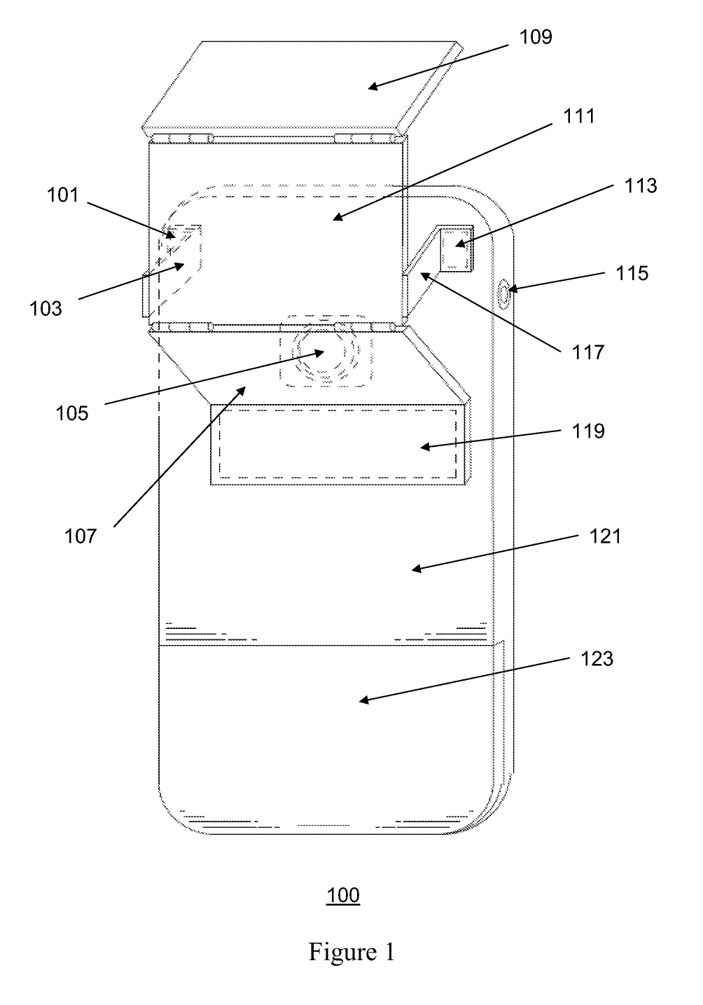

FIG. 1 shows a rear view of an apparatus (100) for changing an image-capturing position of a mobile phone camera using reflective mirror surfaces (i.e. front sides of 107 and 109) in accordance with an embodiment of the invention. In a preferred embodiment of the invention, the apparatus (100) as shown in FIG. 1 has a backside of a first mirror (109), a backside of a second mirror (107), a material (111) positioned between the first mirror (109) and the second mirror (107), and a backside of a first Velcro surface (119) attached to a rear surface (121) of a mobile phone. In a preferred embodiment of the invention, the backside of the first Velcro surface (119) is simply attached to the rear surface (121) of a mobile phone, as shown in FIG. 1. In another embodiment of the invention, the backside of the first Velcro surface (119) is attached to a mobile phone cover which may encapsulate at least some exterior portions of the mobile phone. The mobile phone may also contain a battery cover (123) and a data and/or audio port (113). Furthermore, in the preferred embodiment of the invention, the backside of the first mirror (109) and the backside of the second mirror (107) are attached to the material (111) by one or more hinges. The one or more hinges enable the mirrors (107, 109) to tilt to desirable positions for image reflection and redirection into a camera lens (105). In one embodiment of the invention, several tilt positions are segmented to make each tilt position to be stationary. In a preferred embodiment of the invention, a front side of the material (111) facing the rear surface (121) of the mobile phone has a non-reflective surface to minimize any undesirable image distortions during image reflection and redirection between a front side of the first mirror (109) and a front side of the second mirror (107).

Furthermore, a first stabilizing arm (103) with a backside of a first stabilizing arm Velcro surface (101) and a second stabilizing arm (117) with a backside of a second stabilizing arm Velcro surface (113) are shown in FIG. 1, wherein the stabilizing arms (103, 117) attached to the rear surface of the mobile phone (121) provide a benefit of stabilizing and maintaining a fixed position and/or distance among the first mirror (109), the second mirror (107), the material (111) between the first and the second mirrors, and the rear surface (121) of the mobile phone. Typically, one or more Velcro surfaces of a particular gender (e.g. male Velcro surface or a female Velcro surface) are placed on the rear surface (121) of the mobile phone to make the corresponding opposite-gender Velcro surfaces on the front sides of stabilizing arm Velcro surfaces (101, 113) and a front side of the first Velcro surface (119) conveniently attachable to and detachable from the rear surface (121) of the mobile phone.

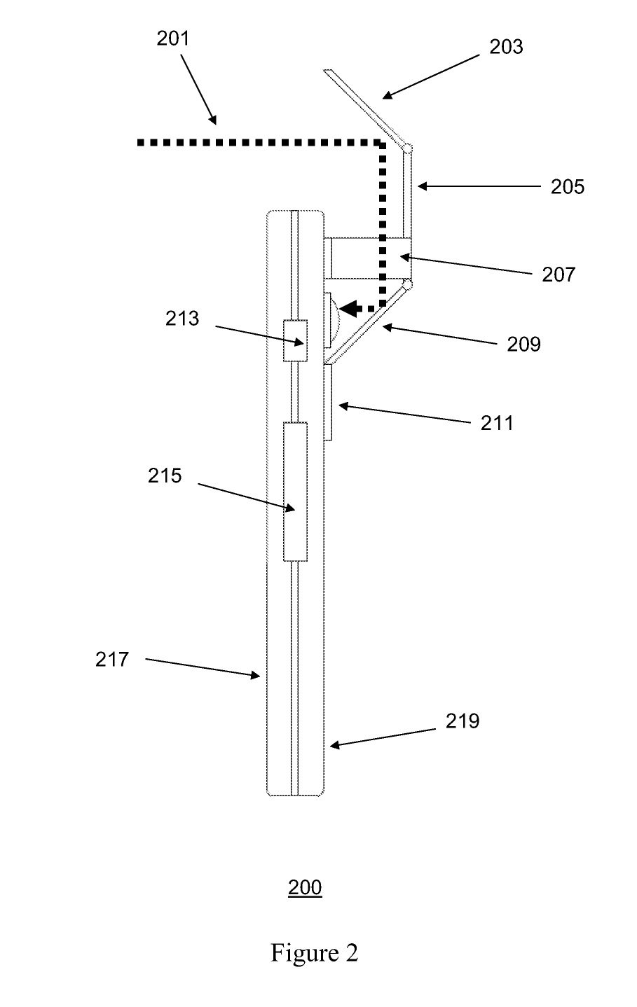

FIG. 2 shows a side view of an apparatus (200) for changing an image-capturing position of a mobile phone camera using reflective mirror surfaces (203, 209), in accordance with an embodiment of the invention. In a preferred embodiment of the invention, the apparatus (200) as shown in FIG. 2 has a first mirror (203) with a first mirror surface on a left side, a second mirror (209) with a second mirror surface on the left side, a material (205) positioned between the first mirror (203) and the second mirror (209), and a first Velcro surface (211) attached to a rear surface (219) of a mobile phone. In another embodiment of the invention, a first Velcro surface (211) is attached to a mobile phone cover which may encapsulate at least some exterior portions of the mobile phone. The mobile phone as shown in FIG. 2 may also contain side buttons (213, 215). As shown by a ray diagram (201), the first mirror surface of the first mirror (203) is capable of reflecting and redirecting an image into a second mirror surface of the second mirror (209), wherein the second mirror surface in turn further reflects and redirects the image into a camera lens (219). In a preferred embodiment of the invention, a reflected and redirected image into the camera lens (219) may be an inverted image of an image source. Therefore, a software program may be useful to invert the reflected and redirected image into the camera lens (219) to derive an original orientation of an image source.

Furthermore, in a preferred embodiment of the invention, the first mirror (203) and the second mirror (209) are attached to the material (205) by one or more hinges. The one or more hinges enable the mirrors (203, 209) to tilt to desirable positions for image reflection and redirection into a camera lens (219). In one embodiment of the invention, several tilt positions are segmented to make each tilt position to be stationary. In a preferred embodiment of the invention, a front side (i.e. a left side of 205 in FIG. 2) of the material (205) has a non-reflective surface to minimize any undesirable image distortions during image reflection and redirection between a front side (i.e. a left side of 203 in FIG. 2) of the first mirror (203) and a front side (i.e. a left side of 209 in FIG. 2) of the second mirror (209).

Furthermore, a stabilizing arm (207) with a backside of a first stabilizing arm Velcro surface is shown in FIG. 2, wherein the stabilizing arm (207) attached to the rear surface (219) of the mobile phone provides a benefit of stabilizing and maintaining a fixed position and/or distance among the first mirror (203), the second mirror (209), the material (205) between the first and the second mirrors, and the rear surface (219) of the mobile phone. Typically, one or more Velcro surfaces of a particular gender (e.g. male Velcro surface or a female Velcro surface) are placed on the rear surface (219) of the mobile phone to make the corresponding opposite-gender the stabilizing arm Velcro surface (221) and a front side (i.e. left side of 211 in FIG. 2) of the first Velcro surface (211) conveniently attachable to and detachable from the rear surface (219) of the mobile phone. Moreover, in one embodiment of the invention, a front surface (217) of the mobile phone contains a touch-sensitive display panel, a speaker, and/or a microphone. In another embodiment of the invention, the front surface (217) of the mobile phone contains a display panel, a keypad, a speaker, and/or a microphone.

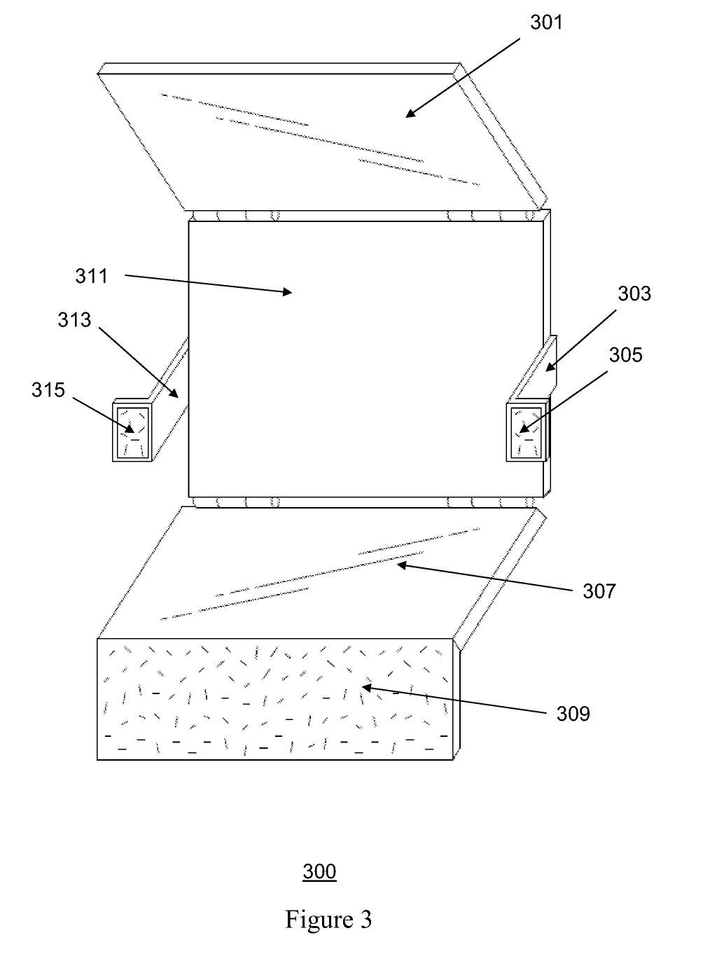

FIG. 3 shows a frontal view of an apparatus (300) for changing an image-capturing position of a mobile phone camera using reflective mirror surfaces (301, 307), in accordance with an embodiment of the invention. In a preferred embodiment of the invention, the apparatus (300) as shown in FIG. 3 shows a first mirror surface (i.e. a front side) of a first mirror (301), a second mirror surface (i.e. a front side) of a second mirror (307), a material (311) positioned between the first mirror (301) and the second mirror (307), and a front side of a first Velcro surface (309) configured to be attached to a rear surface of a mobile phone. Furthermore, in the preferred embodiment of the invention, the first mirror (301) and the second mirror (307) are attached to the material (311) by one or more hinges. The one or more hinges enable the mirrors (301, 307) to tilt to desirable positions for image reflection and redirection into a camera lens. In one embodiment of the invention, several tilt positions are segmented to make each tilt position to be stationary. In a preferred embodiment of the invention, a front side of the material (311) facing the rear surface of the mobile phone has a non-reflective surface to minimize any undesirable image distortions during image reflection and redirection between a first mirror surface (i.e. front side) of the first mirror (301) and a second mirror surface (i.e. front side) of the second mirror (307).

Furthermore, a first stabilizing arm (303) with a backside of a first stabilizing arm Velcro surface (305) and a second stabilizing arm (313) with a backside of a second stabilizing arm Velcro surface (315) are shown in FIG. 3, wherein the stabilizing arms (303, 313) attached to the rear surface of the mobile phone provide a benefit of stabilizing and maintaining a fixed position and/or distance among the first mirror (301), the second mirror (307), the material (311) between the first and the second mirrors, and the rear surface of the mobile phone. Typically, one or more Velcro surfaces of a particular gender (e.g. male Velcro surface or a female Velcro surface) are placed on the rear surface of the mobile phone to make the corresponding opposite-gender Velcro surfaces on the front sides of stabilizing arm Velcro surfaces (305, 315) and a front side of the first Velcro surface (309) conveniently attachable to and detachable from the rear surface of the mobile phone.

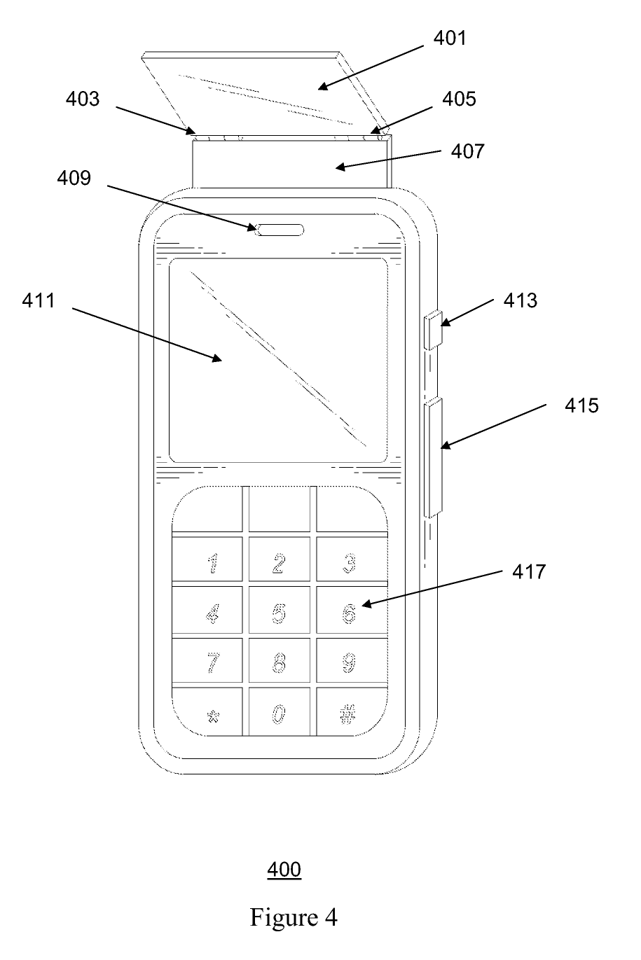

FIG. 4 shows a frontal view (400) of a mobile phone and a partial frontal view of an apparatus for changing an image-capturing position of a mobile phone camera using reflective mirror surfaces, in accordance with an embodiment of the invention. In a preferred embodiment of the invention, the mobile phone as shown in FIG. 4 has a keypad (417), one or more functional buttons (413, 415), an earpiece (409), and a display screen (411). The keypad (417) is typically used to enter digits or alphabets into the mobile phone. In one embodiment of the invention, the keypad (417) may simply be part of the display screen (411) as a touch screen-enabled keypad. Furthermore, the one or more functional buttons (413, 415) are typically used to initiate a particular feature of the mobile phone, such as activating a cell phone camera, activating a cell phone music player, or locking at least some buttons and/or the display screen (411). In addition, the display screen (411) is configured to display at least some features related to the mobile phone and can also be used as an interface to recognize touch-sensitive feedback from a user, if the display screen (411) is a touch screen device. Moreover, the earpiece (409) is typically located on a top portion of a front surface of a mobile phone and is capable of generating audible sound to the user with a speaker. In a preferred embodiment of the invention, the earpiece (409) may be configured to generate a substantial audible volume to operate as a speakerphone if a user selects a speakerphone mode. The earpiece (409) is also typically designed to generate a smaller audible volume for a non-speakerphone mode. Furthermore, the earpiece (409) can also integrate a microphone, or the microphone can be located at a separate location somewhere on the mobile phone.

Continuing with FIG. 4, the partial frontal view of the apparatus for changing an image-capturing position of a mobile phone camera using reflective mirror surfaces reveals a first mirror (401) operatively connected to a material (407) between the first mirror (401) and a second mirror, which is typically positioned below the first mirror (401) and the material (407). In a preferred embodiment of the invention, the material (407) between the first mirror (401) and the second mirror is made of a non-reflective surface to minimize any reflective and/or optical interferences with images captured and redirected by the first mirror (401) and the second mirror. Furthermore, in one embodiment of the invention, the first mirror (401) is operatively connected to the material (407) with a first hinge (403) and a second hinge (405). The first hinge (403) and the second hinge (405) are typically designed to change angles of the first mirror (401) relative to the material (407) between the first mirror (401) and the second mirror. In the preferred embodiment of the invention, by changing the angles of the first mirror (401) relative to the material (407) between the first mirror (401) and the second mirror, a user can get a varying and/or desired angle for an image-capturing position of a mobile phone camera.

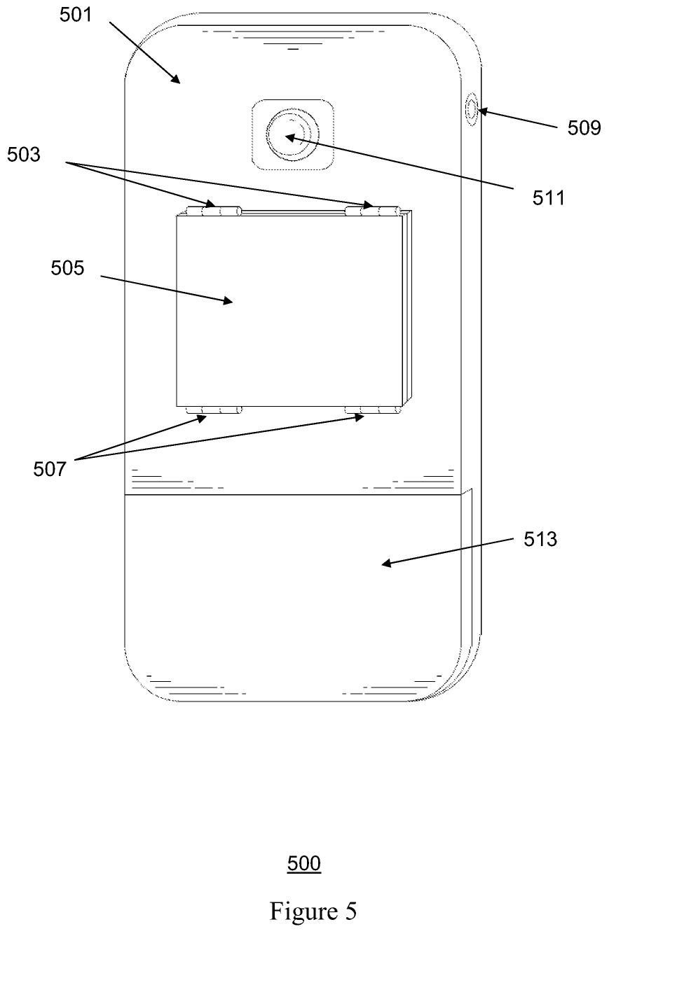

FIG. 5 shows a rear view (500) of a mobile phone and a rear view of a folded apparatus (505) for changing an image-capturing position of a mobile phone camera using reflective mirror surfaces, in accordance with an embodiment of the invention. In a preferred embodiment of the invention, the folded apparatus (505) for changing the image-capturing position of the mobile phone camera using reflective mirror surfaces comprises a first mirror, a second mirror, a set of upper hinges (503), a set of lower hinges (507), and optionally one or more stabilizing arms. In the preferred embodiment of the invention, the first mirror and the second mirror can be folded using the set of upper hinges (503) and the set of lower hinges (507) into a position of the folded apparatus (505) as shown in FIG. 5. Furthermore, in one embodiment of the invention, the one or more stabilizing arms which may be optionally present as part of the folded apparatus (505) can neatly fold into the folded apparatus (505).

FIG. 5 also shows a camera lens (511) attached on a rear surface of a mobile phone, a data and/or audio port (509) on a side surface of the mobile phone, and a battery cover (513). The physical locations of the camera lens (511), the data and/or audio port (509), and the battery cover (513) are merely one example of the invention and by no means limit the scope of the invention or the claims. In one embodiment of the invention, the folded apparatus (505) may be attached to a surface of a mobile phone cover encapsulating at least a portion of the mobile phone, instead of being attached to the rear surface of the mobile phone (501).

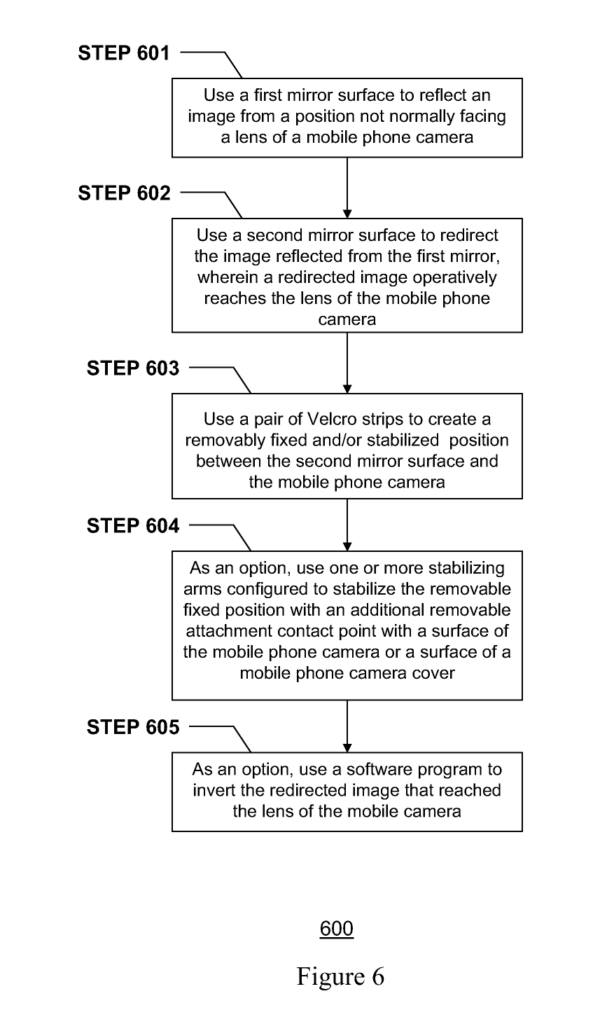

FIG. 6 shows a method (600) for operating an apparatus for changing an image-capturing position of a mobile phone camera using reflective mirror surfaces, in accordance with an embodiment of the invention. In STEP 601, a first mirror surface is used to reflect and redirect an image from a position not normally facing a mobile phone camera lens. Then, in STEP 602, a second mirror surface is used to redirect the image reflected and redirected from the first mirror surface, wherein the redirected image from the second mirror surface operatively reaches the mobile phone camera lens. A pair of Velcro strips can crate a removable fixed and/or stabilized position between the second mirror surface and the mobile phone camera, as shown in STEP 603. Then, as an optional step, one or more stabilizing arms can be used for stabilizing the removable fixed position with an additional removable attachment contact point with a surface of the mobile phone camera or a surface of a mobile phone camera cover, as shown in STEP 604. Then, also as an optional step, a software program can be utilized to invert the redirected image that reached the mobile camera lens, as shown in STEP 605. Redirected images with two mirror surface reflections as configured in FIGS. 1 and 2 may be an inversion of an original image source. Therefore, the software program which inverts the redirected image received by the mobile camera lens reinstates an original orientation of the original image source.

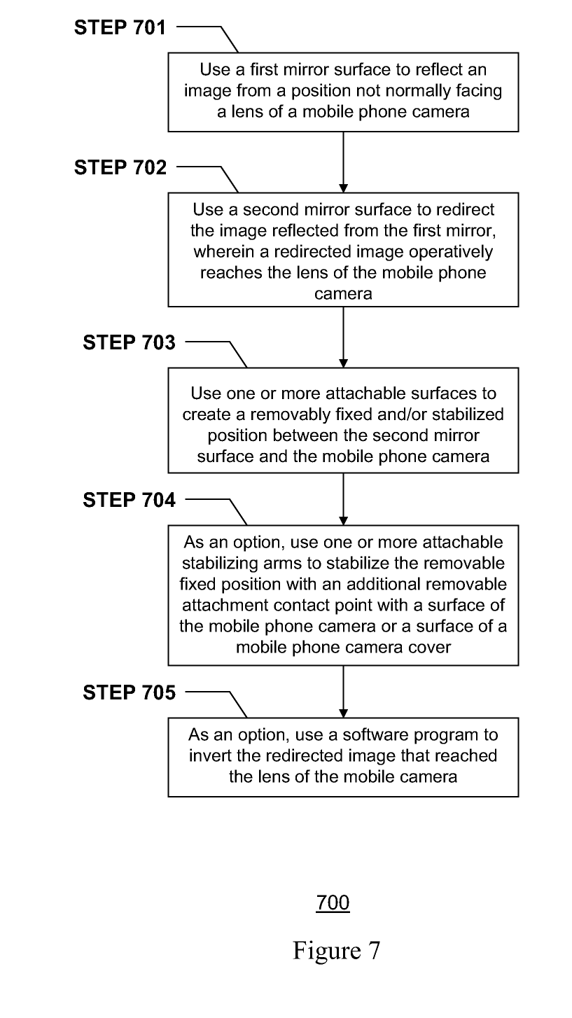

FIG. 7 shows another method (700) for operating an apparatus for changing an image-capturing position of a mobile phone camera using reflective mirror surfaces, in accordance with an embodiment of the invention. In STEP 701, a first mirror surface is used to reflect and redirect an image from a position not normally facing a mobile phone camera lens. Then, in STEP 702, a second mirror surface is used to redirect the image reflected and redirected from the first mirror surface, wherein the redirected image from the second mirror surface operatively reaches the mobile phone camera lens. One or more attachable surfaces can crate a removable fixed and/or stabilized position between the second mirror surface and the mobile phone camera, as shown in STEP 703. Then, as an optional step, one or more stabilizing arms can be used for stabilizing the removable fixed position with an additional removable attachment contact point with a surface of the mobile phone camera or a surface of a mobile phone camera cover, as shown in STEP 704. Then, also as an optional step, a software program can be utilized to invert the redirected image that reached the mobile camera lens, as shown in STEP 705. Redirected images with two mirror surface reflections as configured in FIGS. 1 and 2 may be an inversion of an original image source. Therefore, the software program which inverts the redirected image received by the mobile camera lens reinstates an original orientation of the original image source.

One or more apparatuses and methods for changing an image-capturing position of a mobile phone camera using a mirror device have been disclosed. One advantage of the present invention is providing a cost-effective apparatus capable of changing an image-capturing position of a mobile phone camera using mirrors. Another advantage of the present invention is making such a cost-effective apparatus easily attachable and detachable from a surface of a mobile phone. Yet another advantage of the present invention is making an apparatus capable of changing an image-capturing position of a mobile phone camera using mirrors compact and unobtrusive when the apparatus is not in use.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus for changing an image-capturing position of a mobile phone camera using a mirror device, the apparatus comprising:
a first mirror surface configured to reflect an image into a second mirror surface, wherein the second mirror surface further reflects the image into a lens of the mobile phone camera;
a material positioned between the first mirror surface and the second mirror surface, wherein the material has one or more hinges to connect the first mirror surface to the material and the second mirror surface to the material;
a first Velcro surface attached to the apparatus;
a second Velcro surface attached to a surface exposing the lens of the mobile phone camera, wherein the first Velcro surface and the second Velcro surface are configured to create a removable fixed position for the apparatus upon contact and wherein the surface exposing the lens of the mobile phone camera is either part of the mobile phone camera itself or part of a mobile phone camera cover; and
a stabilizing arm attached to the apparatus, wherein the stabilizing arm is configured to stabilize the removable fixed position with an additional removable attachment contact point with a surface of the mobile phone camera.

2. The apparatus of claim 1, wherein the one or more hinges can change an angle between the first mirror surface and the second mirror surface.

3. The apparatus of claim 1, wherein the one or more hinges guide the first mirror surface and the second mirror surface to a predefined angular position between the first mirror surface and the second mirror surface.

4. The apparatus of claim 1, wherein the stabilizing arm uses a third Velcro surface configured to be attached removably to the surface of the mobile phone camera containing a fourth Velcro surface.

5. The apparatus of claim 1, wherein the first mirror surface at least partially faces the image.

6. A method for changing an image-capturing position of a mobile phone camera using a mirror device, the method comprising the steps of:
using a first mirror surface to reflect an image from a position not normally facing a lens of the mobile phone camera;
using a second mirror surface to redirect the image reflected from the first mirror, wherein a redirected image operatively reaches the lens of the mobile phone camera; and
using a pair of Velcro strips to create a removably fixed and/or stabilized position between the second mirror surface and the mobile phone camera.

7. The method of claim 6, further comprising a step of using a stabilizing arm configured to stabilize the removably fixed position with an additional removable attachment contact point with a surface of the mobile phone camera or with a surface of a mobile phone camera cover, wherein the stabilizing arm has a stabilizing arm Velcro surface attachable to the surface of the mobile phone camera or to the surface of the mobile phone camera cover.

8. The method of claim 6, further comprising a step of using a software program to invert the redirected image that reached the lens of the mobile phone camera.

9. The method of claim 6, wherein the first mirror surface and the second mirror surface are connected by a non-reflective material between the first mirror surface and the second mirror surface using one or more hinges.

10. The method of claim 9, wherein the stabilizing arm is also attached to the non-reflective material.

11. A method for changing an image-capturing position of a mobile phone camera using a mirror device, the method comprising the steps of:
using a first mirror surface to reflect an image from a position not normally facing a lens of the mobile phone camera;
using a second mirror surface to redirect the image reflected from the first mirror, wherein a redirected image operatively reaches the lens of the mobile phone camera; and
using one or more attachable surfaces to create a removably fixed and/or stabilized position between the second mirror surface and the mobile phone camera.

12. The method of claim 11, further comprising a step of using a stabilizing arm configured to stabilize the removably fixed and/or stabilized position with an additional removable attachment contact point with a surface of the mobile phone camera or with a surface of a mobile phone camera cover, wherein the stabilizing arm has a surface attachable to the surface of the mobile phone camera or to the surface of the mobile phone camera cover.

13. The method of claim 11, further comprising a step of using a software program to invert the redirected image that reached the lens of the mobile phone camera.

14. The method of claim 11, wherein the first mirror surface and the second mirror surface are connected by a non-reflective material between the first mirror surface and the second mirror surface using one or more hinges.

15. The method of claim 14, wherein the stabilizing arm is also attached to the non-reflective material.
